(19) United States
(12) Patent Application Publication
(10) Pub. No.: US 2013/0112888 A1
(43) Pub. Date: May 9, 2013

(54) Ion chamber/beam position monitor

(71) Applicants: Alex K. Deyhim, Ithaca, NY (US); Eric C. Van Every, Lansing, NY (US)

(72) Inventors: Alex K. Deyhim, Ithaca, NY (US); Eric C. Van Every, Lansing, NY (US)

(21) Appl. No.: 13/373,155

(22) Filed: Nov. 7, 2011

(51) Int. Cl. G01T 1/185

(52) U.S. Cl. 250/389

(57) ABSTRACT

An ionization chamber that serves as a radiation detector/beam position monitor for beamline applications. When two chambers are paired together in a 90° rotation orientation, the device can be used for beam position monitoring, detection and recording of location of beam bunches moving within the beamline, by detecting horizontal and vertical beam position. This feature allows for ease of use as well as multiple use applications for the chambers, resulting in the need for less additional parts.

### CROSS REFERENCE TO RELATED APPLICATIONS

Not applicable

### STATEMENT REGARDING FEDERALLY SPONSORED RESEARCH OR DEVELOPMENT

Not applicable

### SEQUENCE LISTING OR PROGRAM

Not applicable

### BACKGROUND OF THE INVENTION

An ionization chamber is a gas filled chamber that serves as a radiation detector. It is the simplest of all devices in this category and detects or measures ionizing radiation. The device described herein is for use in beamline applications. When two chambers are paired together in a 90° rotation orientation, the device can be used for beam position monitoring, detection and recording of location of beam bunches moving within the beamline, by detecting horizontal and vertical beam position. This feature allows for ease of use as well as multiple use applications for the chambers, resulting in the need for less additional parts.

### SUMMARY OF THE INVENTION

The device is designed for precise, low noise x-ray measurement. The device allows the user to determine the change in beam position in a single axis by comparing two signals that are created as the beam passes through the ion chamber. By connecting two ion chambers together at 90°, the user can determine the horizontal and vertical beam position.

The unique feature of this precision ion chamber is the incorporation of a split collector plate. The electrode is split into a saw tooth configuration, such that when the differential current in computed, it allows the use as a beam position monitor.

The electrodes are constructed of nickel plated copper on fiberglass supports, all housed within a nickel plated aluminum frame. The high voltage electrode is connected to a SHV, safe high voltage, connector. The low voltage electrodes are connected to BNC, Bayonet Neill-Concelman, connectors.

The system can be configured for air, vacuum operation, or ultra-high vacuum through one of three interfaces. The air system stands alone and is mounted to the system table. The vacuum configuration interfaces are through a bulkhead fitting style or a conflat adapter in several sizes. The ultra-high vacuum configuration replaces the standard Kapton windows with beryllium windows and interfaces through a CF flange.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 is a schematic if the ion chamber/beam position monitor, in the X direction.

FIG. 2 is a schematic of the ion chamber/beam position monitor in the X and Y direction.

FIG. 3 is an example of a conflat adapter.

FIG. 4 is another example of a conflat adaptor.

FIG. 5 is 4.5″ conflat adaptor.

FIG. 6 is a 6″ conflat adaptor.

FIG. 7 is a schematic of the low voltage electrode.

FIG. 8 is a schematic of the high voltage electrode.

FIG. 9 is a schematic of the mounting bracket.

### DETAILED DESCRIPTION OF INVENTION

Provided herein is a detailed description of one embodiment of the invention. Therefore, specific details enclosed herein are not to be interpreted as limiting, but rather as a basis for the claims and as a representative basis for teaching one skilled in the art to employ the present invention in virtually any appropriately detailed system, structure, or manner.

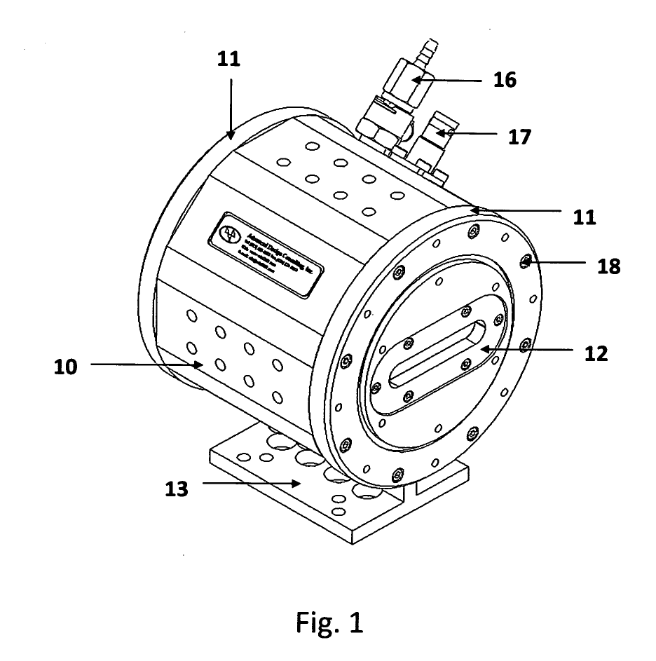

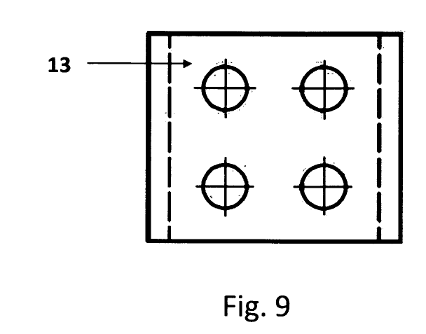

FIG. 1 represents the overall ion chamber design. As previously stated, this ion chamber is designed for accurate, low noise x-ray measurement. The chamber shell assembly 10 is made of nickel plated aluminum and features aluminum end caps 11 secured with eight screws 18. The ion chamber is installed with a 1 mil (25 um) kapton film on both the air and rough vacuum versions, serving as chamber windows 12. Other thicknesses of kapton film can include 2 mil and 5 mil and can be easily replaced. In UHV versions, the kapton film would be replaced with beryllium windows, as beryllium is stronger in UHV applications. The ion chamber also has a mounting bracket 13 attached to the underside, FIG. 9. The mounting bracket helps with set up and is made to be attached to another surface. The ion chamber is “top heavy” and can easily fall over if not securely mounted to another surface. Also visible in FIG. 1 is one of the two Colder MCD1002 ¼″ hose ‘push-to-connect’ normally closed valved gas connectors 16. These are for use in all three applications (air, rough vacuum & UHV). The insert a Colder MCD2202 ⅛″ hose barb non-valved in-line coupling 17, is also visible.

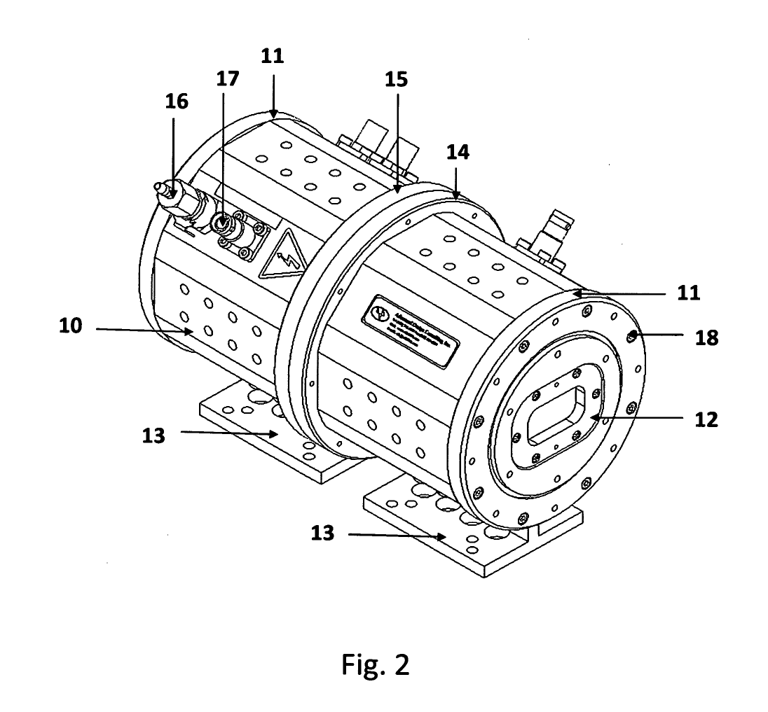

FIG. 2 is a demonstration of the pairing together of two ion chambers for use as a beam position monitor. It can be noted that in this configuration, one chamber is 90° opposite the other chamber, as to aid in determination of both horizontal and vertical beam position. As in FIG. 1, the shell assembly 10 of both chambers is constructed of nickel plated aluminum and features aluminum end caps 11 secured with 8 screws 18. The kapton window assembly 12 is present as well as two ion chamber mounting brackets 13. In this application, the coupling requires a 2 axis coupling tapped adapter 14 and 2 axis coupling thru adapter 15 to create the connection between to two chambers. The gas connector 16 and non-valved in-line coupling 17 is also visible, as previously described.

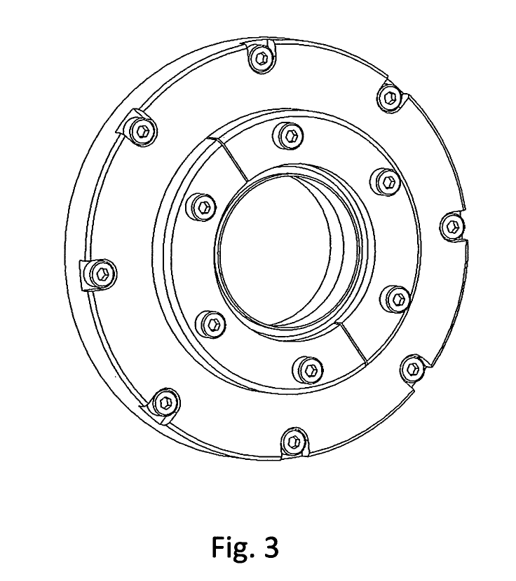

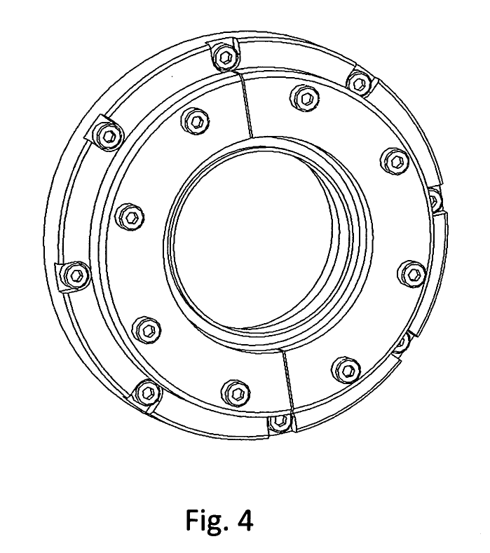

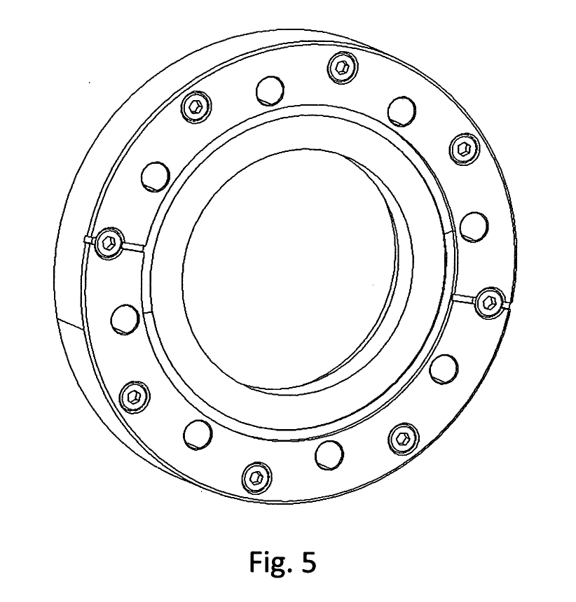

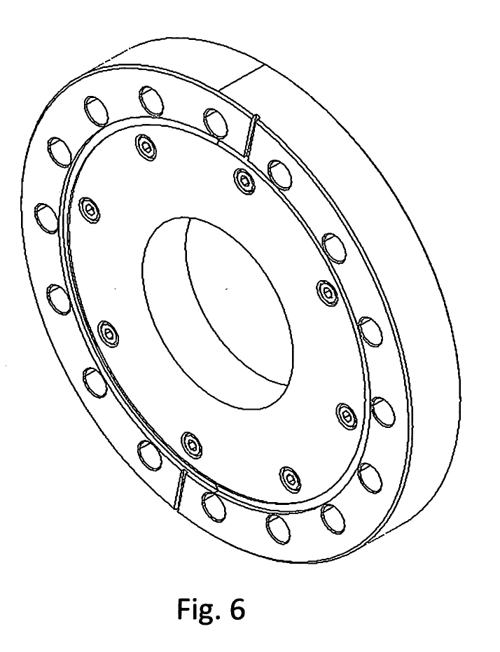

FIGS. 3-6 are images of ion chamber adapters for different applications within beamline. FIG. 3 is an NW40 conflat adapter kit. FIG. 4 is an NW50 conflat adapter kit. FIG. 5 is a 4.5″ conflat adapter kit. FIG. 6 is a 6″ conflat adapter kit.

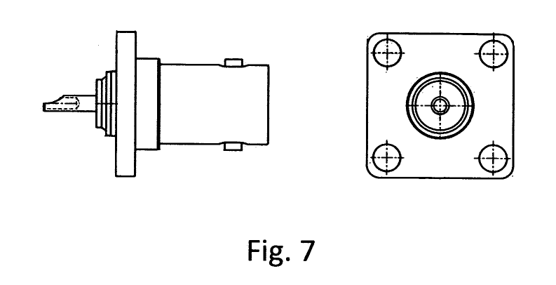

FIG. 7 is a schematic of the low voltage electrode. The electrode used is a Huber & Suhner part number 22540355 Female BNC Panel Mount connector with a nominal impedance of 50 Ohms to connect with the low electrode. The low voltage electrode is constructed of nickel plated copper on fiberglass supports.

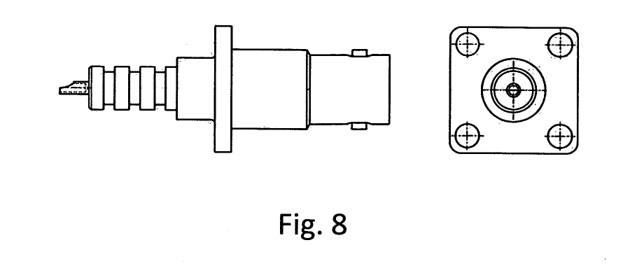

FIG. 8 is a schematic of the high voltage electrode. The electrode connects through a Huber & Suhner part number 22542010, SHV RF Panel Mount connector with a nominal impedance of 50 Ohms. The high voltage electrode is constructed of a nickel plated copper on fiberglass supports.

For both electrodes, high voltage and low voltage, the electrode is split in a saw tooth configuration with height proximity of approximately 10 mm that, when the differential current is computed, allows the use as a beam position monitor. A split collector plate is also incorporated. The electrode spacing can be changed by removing the end cap and the eight screws 18. The electrode boards may be pulled out and reinserted into the desired slot spacing.

What is claimed is:

1. An ion chamber comprising:
(a) A shell assembly;
(b) End caps;
(c) A kapton window assembly;
(d) A low voltage electrode;
(e) A high voltage electrode;
(f) Two gas connectors;
(g) And a non-valved in-line coupling.

2. The apparatus of claim 1 wherein said ion chamber can be configured for air, rough vacuum or high vacuum applications.

3. The apparatus of claim 1 wherein said ion chamber can be paired with an adapter kit to fit within several types of applications.

4. The apparatus of claim 3 wherein said adapter kit can be either NW25, NW40, NW50, 4.5″ conflat or 6″ conflat.

5. The apparatus of claim 1 wherein said shell assembly is made of nickel plated aluminum.

6. The apparatus of claim 1 wherein said end caps are made of aluminum.

7. The apparatus of claim 1 wherein said kapton window assembly is comprised of 1 mil kapton film.

8. The apparatus of claim 7 wherein said kapton film can also be 2 mil and 5 mil in thickness.

9. The apparatus of claim 7 wherein said window assembly can be changed from kapton to beryllium for UHV applications.

10. The apparatus of claim 1 wherein said low voltage electrode is comprised of nickel plated copper on fiberglass supports.

11. The apparatus of claim 10 wherein said low voltage electrode uses a Huber & Suhner female BNC Panel Mount connector.

12. The apparatus of claim 1 wherein said high voltage electrode is comprised of nickel plated copper on fiberglass supports.

13. The apparatus of claim 12 wherein said high voltage connector uses a Huber & Suhner SHV RF Panel Mount connector.

14. The apparatus of claim 1 wherein said electrodes, both low voltage and high voltage, are split into a saw tooth configuration that, when the differential current is computed, allows the use as a beam position monitor.

15. The apparatus of claim 1 wherein said electrodes, both low voltage and high voltage, spacing can be changed by removing end cap apparatus of claim 1, removing electrode boards and reinserting into desired slot spacing.

16. The apparatus of claim 1 wherein said ion chamber can be paired with another chamber at 90° to create a beam position monitor.

17. The apparatus of claim 16 wherein said paring occurs by utilizing a 2 axis tapped coupling and a 2 axis thru coupling between the two ion chambers.

18. The apparatus of claim 1 wherein said gas connectors are Colder ¼″ hose ‘push-to-connect’ type.

19. The apparatus of claim 1 wherein said non-valved in-line coupling is a Colder ⅛″ hose barb type.
